(19) United States
(12) Patent Application Publication
(10) Pub. No.: US 2025/0369084 A1
(43) Pub. Date: Dec. 4, 2025

(54) HIGH-ENTROPY ALLOY POWDERS, BRAKE DISC COATINGS, AND METHODS FOR PREPARING BRAKE DISC COATINGS

(71) Applicant: Q-CARBON MATERIAL CO., LTD., Shanghai (CN)

(72) Inventors: Fuqiang SHEN, Shanghai (CN); Weijian SHI, Shanghai (CN)

(73) Assignee: Q-CARBON MATERIAL CO., LTD., Shanghai (CN)

(21) Appl. No.: 19/300,631

(22) Filed: Aug. 14, 2025

Related U.S. Application Data
(63) Continuation-in-part of application No. PCT/CN2025/085774, filed on Mar. 28, 2025.

(30) Foreign Application Priority Data
Apr. 1, 2024 (CN) 202410386755.3

(51) Int. Cl. C23C 4/08; B22F 9/08; C22C 1/02; C22C 30/02; C23C 4/02; C23C 4/134; F16D 65/12; F16D 69/02

(52) U.S. Cl. CPC C23C 4/08; B22F 9/082; C22C 1/02; C22C 30/02; C23C 4/02; C23C 4/134; F16D 65/127; F16D 69/027; B22F 2009/0848; B22F 2201/10; B22F 2998/10; B22F 2999/00; F16D 2200/003; F16D 2250/0046

(57) ABSTRACT

The present disclosure provides a brake disc coating and a method for preparing the brake disc coating. The brake disc coating is prepared from a high-entropy alloy powder, a preparation material of the high-entropy alloy powder includes an Al powder, a Co powder, a Ni powder, a Cu powder, and a Ti powder, a molar ratio of metal elements Al, Co, Ni, Cu, and Ti in the high-entropy alloy powder is in a range of 1:1:1:1:(1.1-1.3), and the high-entropy alloy powder has a single body-centered cubic (BCC) crystal structure.

### CROSS-REFERENCE TO RELATED APPLICATIONS

This application is a continuation-in-part application of International Application No. PCT/CN2025/085774, filed on Mar. 28, 2025, which claims priority of Chinese patent Application No. 202410386755.3, filed on Apr. 1, 2024, the entire contents of each of which are incorporated herein by reference.

### TECHNICAL FIELD

The present disclosure generally relates to the field of metal coating materials and thermal spraying technology, and in particular, to high-entropy alloy powders, brake disc coatings, and methods for preparing the brake disc coatings.

### BACKGROUND

The brake disc, also known as the brake disk, is a metal disk made of alloy steel and is fixed to the wheel and rotates with the wheel. The brake caliper clamps down on the brake disc when the brake is pressed during driving to slow down or stop the vehicle. Generally, there are round holes on the brake discs to reduce weight and increase friction. There are many different types of brake discs, characterized by thin walls, with the disc body and center formed by sand cores. The different types of brake discs differ in disc diameter, disc thickness and two-piece gap dimensions, as well as in the thickness and height of the disc hubs.

While the gray cast iron material is well suited for manufacturing brake discs, the hardness of the gray cast iron material is low (about 200 HV) and its wear resistance is limited. The brake discs are consumable parts of the braking system. If the brake discs are badly worn, the difference between the actual braking distance and the expected braking distance will be significant, thus affecting driving maneuverability and safety. Currently, gray cast iron remains the primary material for the brake discs made in China, which is low-cost, high-strength, durable, has a high melting point, and prevents softening under frictional heat. However, with the advancements in science and technology, this traditional metal material is not able to meet the service requirements of various working conditions under various operating conditions due to its single mechanical property, susceptibility to oxidation and rust, poor thermal fatigue resistance, braking and wear resistance. Therefore, there is an urgent need for technological upgrades in brake disc materials.

High-entropy alloys are a novel class of alloys developed in the last decades, with four major effects: high-entropy effect on thermodynamics, sluggish diffusion effect on kinetics, lattice mismatch effect on crystal structure, and cocktail effect on properties. The high-entropy alloys exhibit a variety of excellent properties, such as high strength, high hardness, excellent abrasion resistance, corrosion resistance, low-temperature resistance, high-temperature oxidation resistance, and tempering softening resistance.

Compared with other technologies, thermal spraying technology mainly includes the following unique advantages. First, there are more than ten kinds of spraying methods, which can be comprehensively selected according to the demand of performance, type of substrate, equipment conditions, and production efficiency, etc. Second, a wide range of spraying materials, with sufficiently high temperatures in the heating zone to process even refractory materials. Third, a wide range of applicability, unrestricted by the workpiece size and site limitations. Fourth, the coating thickness is controllable.

Patent CN106756717A discloses a method of preparing a high-strength wear-resistant copper-nickel-tin alloy coating. Specifically, it discloses that a Cu15Ni8SnNb coating is prepared on a stainless steel substrate using a thermal spray method, and that the prepared alloy coating's wear resistance is better than that of the same material alloy block and the depth of the coating wear marks is significantly smaller than that of the same material alloy material. However, the wear rate is still higher compared to the present disclosure.

There is a need to provide an alloy coating with superior abrasion and corrosion resistance properties for use in the automotive brake disc industry.

### SUMMARY

To address the shortcomings of the prior art, the present disclosure aims to provide a high-entropy alloy powder, a brake disc coating, and a method for preparing the brake disc coating. The brake disc coating of the present disclosure has good interlayer bonding, dense microstructure, and excellent wear and corrosion resistance.

The present disclosure provides a brake disc coating. The coating may be prepared from high-entropy alloy powder. A preparation material of the high-entropy alloy powder may include aluminum (Al) powder, cobalt (Co) powder, nickel (Ni) powder, copper (Cu) powder, and titanium (Ti) powder. A molar ratio of metal elements Al, Co, Ni, Cu, and Ti in the high-entropy alloy powder may be in a range of 1:1:1:1:(1.1-1.3), and the high-entropy alloy powder may have a single body-centered cubic (BCC) crystal structure.

The present disclosure provides a method for preparing a brake disc coating. The brake disc coating may be prepared from a high-entropy alloy powder. A preparation material of the high-entropy alloy powder may include Al powder, Co powder, Ni powder, Cu powder, and Ti powder. A molar ratio of metal elements Al, Co, Ni, Cu, and Ti in the high-entropy alloy powder may be in a range of 1:1:1:1:(1.1-1.3), and the high-entropy alloy powder may have a single BCC crystal structure. The method may include: (1) mixing the Al powder, the Co powder, the Ni powder, the Cu powder, and the Ti powder based on the molar ratio, then performing gas atomization and sieving, to obtain the high-entropy alloy powder; (2) preheating the high-entropy alloy powder obtained in operation (1) to obtain a standby alloy powder; (3) performing atmospheric plasma spraying on a surface of a brake disc base after pre-treatment using the standby alloy powder as a spraying material, to obtain the brake disc coating.

Compared with the prior art, the present disclosure has the following beneficial effects.

First, the high-entropy alloy powder of the present disclosure has a high-entropy effect due to its special BCC solid solution phase crystal structure, which substantially improves the solubility of the alloy system and metal compounds and enhances the bonding of the alloy with the metal compounds.

Second, the present disclosure adopts gas atomization to prepare high-entropy alloy powder, which makes the obtained powder with good sphericity and ensures good fluidity of the powder during the spraying process.

Third, the high-entropy alloy powder of the present disclosure has a sluggish diffusion effect. In the oversaturated solid solution, it is easy to precipitate hard phases and achieving diffusion strengthening. The precipitated hard phases are easy to form an oxidized protective glaze layer during the friction process of the coating, to achieve a significant improvement in the friction performance of the coating.

Fourth, the present disclosure adopts plasma spraying technology to prepare brake disc coating, which is low-cost and suitable for application in industrial production. The prepared coatings are characterized by high hardness, abrasion resistance and corrosion resistance.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is an X-ray diffraction (XRD) pattern of a brake disc coating and high-entropy alloy powder according to embodiment 3 of the present disclosure;

FIG. 2 is a cross-sectional scanning electron microscope (SEM) image of a brake disc coating according to embodiment 3 of the present disclosure;

FIG. 3 is an SEM image of a surface of a brake disc coating after friction testing according to embodiment 3 of the present disclosure; and

FIG. 4 is an SEM image of a surface of a brake disc coating after corrosion testing according to embodiment 3 of the present disclosure.

### DETAILED DESCRIPTION

The brake discs are disc-shaped braking devices commonly used in vehicles and industrial machinery. In order to enhance the abrasion and corrosion resistance performance of existing brake discs, some embodiments of the present disclosure provide a brake disc coating to cover the surface of the brake disc.

In some embodiments, the brake disc coating (hereinafter referred to as the coating) is prepared using high-entropy alloy powder. The high-entropy alloy powder refers to an alloy powder consisting of a plurality of metals with high mixing entropy, which has better high-temperature stability and mechanical properties. The metal element contained in the high-entropy alloy powder and the proportion may be determined according to the actual application scenarios and needs.

In some embodiments, the preparation material for preparing the high-entropy alloy powder may include aluminum (Al) powder, cobalt (Co) powder, nickel (Ni) powder, copper (Cu) powder, and titanium (Ti) powder.

In some embodiments, the preparation material of the high-entropy alloy powder further includes one or a combination of niobium (Nb) powder, boron (B) powder, and silicon (Si) powder.

In some embodiments of the present disclosure, the preparation material of the high-entropy alloy powder further includes one or a combination of the Nb powder, the B powder, and the Si powder, which helps to promote the refinement of the grains and improve the amorphous formation ability, improve the temperature resistance and wear resistance of the brake disc coating in extreme environments, such as high temperatures.

In some embodiments, the molar ratio of the metal elements Al, Co, Ni, Cu, and Ti in the high-entropy alloy powder is in a range of 1:1:1:1:(1.1-1.3). In some embodiments, the molar ratio of the metal elements Al, Co, Ni, Cu and Ti in the high-entropy alloy powder is in a range of 1:1:1:1:(1.2-1.3). In some embodiments, the molar ratio of metal elements Al, Co, Ni, Cu and Ti in the high-entropy alloy powder is in a range of 1:1:1:1:(1.1-1.2). For example, the molar ratios of the metal elements Al, Co, Ni, Cu, and Ti in the high-entropy alloy powder may be 1:1:1:1:1.1, 1:1:1:1:1.2, or 1:1:1:1:1.3, but is not limited to the enumerated values, and any other values in the value range that are not enumerated apply as well.

In some embodiments, the high-entropy alloy powder has a single body-centered cubic (BCC) crystal structure.

In some embodiments, the present disclosure uses Al powder, Co powder, Ni powder, Cu powder, and Ti powder with purity larger than or equal to 99.9% as preparation materials to obtain the high-entropy alloy powder with a particle size in a range of 25-75 μm, such that the high-entropy alloy powder has a high purity, and the high-entropy alloy powder has a crystal structure of BCC solid solution phase and thus has a high-entropy effect, which improves the solubility of the alloy system and the metal compound and improves the bonding of the alloy and the metal compound.

The coating may be a multi-gradient coating. The multi-gradient coating at least includes a transition layer, a high-entropy alloy layer, and a surface strengthening layer.

The transition layer is a coating disposed between the brake disc and the high-entropy alloy layer, and the transition layer mitigates the difference in coefficients of thermal expansion between the cast iron substrate and the high-entropy alloy, thereby enhancing interfacial bonding between the multi-gradient coating and the brake disc. In some embodiments, the preparation material of the transition layer is an alloy. For example, the preparation material of the transition layer is nickel-based alloy (NiCrAlY).

The high-entropy alloy layer is a coating that is located between the transition layer and the surface strengthening layer. The high-entropy alloy layer may be obtained by using high-entropy alloy powder. More descriptions of the high-entropy alloy powder may be found hereinabove.

The surface strengthening layer is a coating located outside the high-entropy alloy layer. The surface strengthening layer has a high hardness, which enhances the wear resistance of the multi-gradient coating. In some embodiments, the preparation material of the surface strengthening layer includes a high hardness ceramic material (e.g., silicon carbide, titanium carbide, etc.). In other embodiments, the preparation material of the surface strengthening layer includes high-entropy alloy powder and high hardness ceramic material (e.g., silicon carbide, titanium carbide, etc.).

In some embodiments, the preparation material and the thickness of the gradient coating may be determined according to the actual application scenarios and needs.

In some embodiments of the present disclosure, by adopting the multi-gradient coating at least including the transition layer, the high-entropy alloy layer, and the surface strengthening layer as the coating, it is ensured that the bonding between the coating and the brake disc base is more solid, reducing the risk of the coating falling off, and further enhance the wear resistance of the coating surface to make the coating more adaptable to complex and harsh conditions.

In some embodiments, the high-entropy alloy powder has a particle size in a range of 25-75 μm, for example, the particle size may be 25 μm, 30 μm, 35 μm, 40 μm, 45 μm, 50 μm, 55 μm, 60 μm, 65 μm, 70 μm, or 75 μm, the particle size is not limited to the listed values and other values in the value range that are not listed apply equally.

In some embodiments, the Al powder, Co powder, Ni powder, Cu powder, and Ti powder all have a purity larger than or equal to 99.9%, for example, the purity may be 99.9%, 99.92%, 99.94%, 99.96%, 99.98%, or 99.999%. The purity is not limited to the enumerated values, and other non-enumerated values within the range are equally applicable.

In some embodiments of the present disclosure, by setting the particle size of the high-entropy alloy powder to be in the range of 25-75 μm and ensuring that the purity of the Al powder, Co powder, Ni powder, Cu powder, and Ti powder is all larger than or equal to 99.9%, it is ensured that the high-entropy alloy powder may form a dense and uniform coating on the surface of the brake disc during subsequent atmospheric plasma spraying, thus ensuring the quality of the coating. The use of high purity metal powder as the preparation material can reduce the unfavorable effect of impurities on the close bonding between the coating and the brake disc and improve the bonding strength between the coating and the brake disc base.

In some embodiments, the brake disc coating has a thickness in a range of 200-300 μm. For example, the thickness may be 200 μm, 220 μm, 240 μm, 260 μm, 280 μm, or 300 μm. The thickness is not limited to the listed values, and other non-listed values in the numerical range are equally applicable. In some embodiments, the brake disc coating has a thickness in a range of 250-300 μm.

In some embodiments of the present disclosure, the thickness of the brake disc coating in the present disclosure is in a range of 200-300 μm. If the thickness of the coating is too large, it will lead to insufficient bonding strength between the coating and the substrate, making it prone to delamination over time. Additionally, it also increases the cost and reduces the competitiveness of the product. If the thickness of the coating is too small, it will lead to the coating being prone to cracking, shedding and other phenomena, which affects the durability of the coating. In addition, it is prone to be eroded by corrosive media, which reduces the corrosion resistance of the coating, and is prone to be abraded, which exposes the substrate and causes the substrate to be damaged.

In some embodiments, the present disclosure provides a method of preparing the brake disc coating, the method of preparation includes the following operations (1)-(3).

In operation (1), the Al powder, the Co powder, the Ni powder, the Cu powder, and the Ti powder are mixed based on the molar ratio, then subjected to gas atomization. After sieving, a high-entropy alloy powder was obtained.

The gas atomization is a process of melting metal powder, then using high-pressure gas to break the melted metal into tiny droplets, quickly cooling and solidifying the tiny droplets to get powder.

In some embodiments, the gas atomization in operation (1) includes under the protection of the inert gas, performing repeated melting on the Al powder, the Co powder, the Ni powder, the Cu powder, and the Ti powder until molten droplets fall, then performing high-pressure atomization. In some embodiments, the inert gas may include, but is not limited to, argon, helium, nitrogen, or the like. In some embodiments, parameters such as the vacuum degree in the gas atomization, the power in melting the metal powder, the number of the repeated melting, the gas employed for the high-pressure atomization, and the pressure of the high-pressure atomization may be determined according to the actual application scenario and the demand.

In some embodiments, the vacuum degree in the gas atomization is in a range of 2.5×10⁻⁴-3.5×10⁻⁴ Pa. For example, the vacuum degree is 2.5×10⁻⁴ Pa, 2.7×10⁻⁴ Pa, 2.9×10⁻⁴ Pa, 3.1×10⁻⁴ Pa, 3.3×10⁻⁴ Pa, or 3.5×10⁻⁴ Pa, and the vacuum degree is not limited to the enumerated values, and other values within the numerical range that are not enumerated are equally applicable.

In some embodiments, the melting power is in a range of 30-40 kW, for example, the melting power may be 30 kW, 32 kW, 34 kW, 36 kW, 38 kW, or 40 kW. The melting power is not limited to the enumerated values, and other values within the range of values that are not enumerated are equally applicable.

In some embodiments, the number of the repeated melting is in a range of 3-5, for example, the number of the repeated melting is 3, 4, or 5.

In some embodiments, the gas employed for high-pressure atomization includes argon. In some embodiments, the pressure of the high-pressure atomization is in a range of 7.5-8.5 MPa, for example, the pressure is 7.5 MPa, 7.7 MPa, 7.9 MPa, 8.1 MPa, 8.3 MPa, or 8.5 MPa. The pressure is not limited to the enumerated values, and other values within the range of values that are not enumerated are equally applicable.

According to some embodiments of the present disclosure, if the pressure of high-pressure atomization is too high, it may lead to an increase in gas consumption, the particle size of the powder is too small for the formation of the coating by spraying. If the pressure is too low, it may lead to a poor fluidity of the powder and a small loading ratio, and an increase in the particle size of the particles may lead to an irregular and uneven of the coating. By setting the pressure of the high-pressure atomization in the range of 7.5-8.5 MPa, it effectively ensures the formation of a compact and uniform coating on the surface of the brake disc.

In operation (2), the high-entropy alloy powder obtained in operation (1) is preheated to obtain a standby alloy powder.

The preheating refers to an operation of heating and holding the high-entropy alloy powder to remove impurities and moisture from the powder, improve the microstructure, composition uniformity, and flowability of the powder, thereby enhancing the stability of the spraying process and coating performance.

In some embodiments, the temperature of the preheating in operation (2) is in a range of 180-230° C., for example, the temperature is 180° C., 190° C., 200° C., 210° C., 220° C., or 230° C. The temperature is not limited to the enumerated values, and other values within the numerical range that are not enumerated are equally applicable.

In some embodiments, the time of the preheating in operation (2) is in a range of 150-200 min, for example, the time is 150 min, 160 min, 170 min, 180 min, 190 min, or 200 min. The time is not limited to the enumerated values, and other values within the numerical range that are not enumerated are equally applicable.

According to some embodiments of the present disclosure, by preheating the high-entropy alloy powder at the temperature in a range of 180-230° C. for 150-200 min, residual moisture and gas in the high-entropy alloy powder may be effectively removed, thereby enhancing the mobile phase of the high-entropy alloy powder, while avoiding defects such as porosity and cracks in the coating due to vaporization of moisture and expansion of gas in the subsequent atmospheric plasma spraying process, improving the denseness and quality of the coating.

In operation (3), the atmospheric plasma spraying is performed on a surface of a brake disc base after pre-treatment using the standby alloy powder as a spraying material, to obtain the brake disc coating.

The pre-treatment refers to an operation of cleaning the surface of the brake disc base.

In some embodiments, the pre-treatment in operation (3) includes sequentially performing sandblasting pre-treatment, cleaning, and drying on the surface of the brake disc base.

The sandblasting pre-treatment refers to an operation in which the surface of the brake disc base is polished by spraying sandblasting material onto the surface of the brake disc base from the nozzle of a spray gun through compressed air. Parameters such as sandblasting material, particle size, angle between the spray gun and the surface of the brake disc base, compressed air pressure, and sandblasting time in sandblasting pre-treatment may be determined according to actual application scenarios and needs.

In some embodiments, the sandblasting material employed in the sandblasting pre-treatment includes brown fused alumina sand. In some embodiments, the brown fused alumina sand has a particle size of any one or a combination of at least two of 16#, 18#, 20#, 22#, or 24#. Merely by way of example, the combination may include, but is not limited to a combination of 16# brown fused alumina sand and 18# brown fused alumina sand, a combination of 22# brown fused alumina sand and 24# brown fused alumina sand, a combination of 16# brown fused alumina sand, 18# brown fused alumina sand, 20# brown fused alumina sand, and 24# brown fused alumina sand, or a combination of 16# brown fused alumina sand, 18# brown fused alumina sand, 20# brown fused alumina sand, 22# brown fused alumina sand, and 24# brown fused alumina sand.

In some embodiments, the compressed air pressure in the sandblasting pre-treatment is in a range of 0.3-0.8 MPa, for example, the compressed air pressure is 0.3 MPa, 0.4 MPa, 0.5 MPa, 0.6 MPa, 0.7 MPa, or 0.8 MPa. The compressed air pressure is not limited to the listed values, and other values within the numerical range that are not listed are equally applicable.

In some embodiments, the angle between the spray gun and the surface of the brake disc base in the sandblasting pre-treatment is in a range of 40-50°, for example, the angle is 40°, 41°, 42°, 43°, 44°, 45°, 46°, 47°, 48°, 49° or 50°. The angle is not limited to the enumerated values, and other values within the range of values that are not enumerated are equally applicable.

In some embodiments, the cleaning includes a cleaning treatment using a degreaser.

After the sandblasting treatment in the pre-treatment described in the present disclosure, compressed air is first used to repeatedly blow the surface of the substrate, so that the surface is clean and free of dust particles, and then subsequently the degreaser is used to wash the substrate and dry the substrate, to remove any oil that may be left behind.

In some embodiments, the brake disc base is made of cast iron. In some embodiments, the material of the brake disc base may also be other materials, such as steel, titanium alloy, ceramic composite material, or the like. The material of the brake disc base may be determined based on actual application scenarios and needs.

According to some embodiments of the present disclosure, by pre-treating the surface of the brake disc base, dirt such as dust, oxides, and oils on the surface of the brake disc base may be removed, and a clean and dry brake disc base is obtained, which contributes to forming a tightly bonded coating on the surface of the brake disc base.

The atmospheric plasma spraying is a thermal spraying process that utilizes a plasma gas stream to melt the standby alloy powder to melt and impact at high speeds onto the surface of the brake disc base to form a firm and tight coating.

According to some embodiments of the present disclosure, in the atmospheric plasma spraying described in operation (3), the spraying distance is in a range of 100-150 mm, for example, the spraying distance is 100 mm, 110 mm, 120 mm, 130 mm, 140 mm, or 150 mm. The spraying distance is not limited to the enumerated values, and other values within the numerical range that are not enumerated are equally applicable.

In some embodiments, in the atmospheric plasma spraying described in operation (3), the torch moving velocity is in a range of 150-400 mm/s, for example, the torch moving velocity is 150 mm/s, 200 mm/s, 250 mm/s, 300 mm/s, 350 mm/s, or 400 mm/s. The torch moving velocity is not limited to the enumerated values, and other values within the numerical range that are not enumerated are equally applicable. The spraying spacing is 3 mm.

In some embodiments, the number of repetitions of the atmospheric plasma spraying described in operation (3) is in a range of 4-6, for example, the number is 4, 5, or 6.

In some embodiments, the working gas of the atmospheric plasma spraying described in operation (3) may be determined based on actual application scenarios and needs. For example, argon and hydrogen are used as the working gas.

In some embodiments, in the atmospheric plasma spraying described in operation (3), the hydrogen flow rate of the plasma gas stream is in a range of 3-6 L/min, for example, the hydrogen flow rate is 3 L/min, 3.5 L/min, 4 L/min, 4.5 L/min, 5 L/min, 5.5 L/min, or 6 L/min. The hydrogen flow rate is not limited to the enumerated values, and other values within the numerical range that are not enumerated are equally applicable.

In some embodiments, in the atmospheric plasma spraying described in operation (3), the argon flow rate is in a range of 30-50 L/min, for example, the argon flow rate may be 30 L/min, 34 L/min, 38 L/min, 42 L/min, 46 L/min, or 50 L/min. The argon flow rate is not limited to the enumerated values, and other values within the numerical range that are not enumerated are equally applicable.

In some embodiments, in the atmospheric plasma spraying, the spraying current and the spraying voltage may be determined based on actual application scenarios and needs.

In some embodiments, in the atmospheric plasma spraying described in operation (3), the spraying current is in a range of 480-550 A, for example, the spraying current is 480 A, 490 A, 500 A, 510 A, 520 A, 530 A, 540 A, or 550 A. The spraying current is not limited to the enumerated values, and other values within the numerical range that are not enumerated are equally applicable.

In some embodiments, in the atmospheric plasma spraying described in operation (3), the spraying voltage is in a range of 50-60 V, for example, the spraying voltage is 50 V, 52 V, 54 V, 56 V, 58 V, or 60 V. The spraying voltage is not limited to the enumerated values, and other values within the numerical range that are not enumerated are equally applicable.

In some embodiments, in the atmospheric plasma spraying, the powder feeding rate and the powder feeding manner may be determined based on actual application scenarios and needs. For example, the powder feeding manner includes, but is not limited to, axial powder feeding, lateral powder feeding, or the like.

In some embodiments, in the atmospheric plasma spraying described in operation (3), the powder feeding rate is in a range of 2-10 g/min, for example, the powder feeding rate is 2 g/min, 3 g/min, 4 g/min, 5 g/min, 6 g/min, 7 g/min, 8 g/min, 9 g/min, or 10 g/min. The powder feeding rate is not limited to the enumerated values, and other values within the numerical range that are not enumerated are equally applicable.

In some embodiments, in the atmospheric plasma spraying described in operation (3), the powder feeding rate may also be determined by a speed prediction model. More descriptions of the speed prediction model may be found hereinafter.

In some embodiments, the powder feeding manner of the atmospheric plasma spraying described in operation (3) includes vertical jet powder feeding.

The present disclosure adopts the gas atomization to prepare the high-entropy alloy powder with good powder sphericity, so as to ensure the good fluidity of the powder during the spraying process. Then the present disclosure adopts the atmospheric plasma spraying and adjusts the spraying parameters to achieve maximal optimization of micro-morphology of the brake disc coating. Finally, the brake disc coating with good interlayer bonding, dense microstructure, and excellent wear and corrosion resistance is obtained.

In some embodiments, the high-entropy alloy powder described in the present disclosure has a single BCC crystal structure. After atmospheric plasma spraying as described in operation (3), Ni in the alloy undergoes a solid solution reaction after occupying some of the junction positions of the Cu atoms as a solute atom to generate a Cu_{0.81}Ni_{0.19} alloy phase, which yields the face-centered cubic (FCC) crystal structure with Cu_{0.81}Ni_{0.19} and TiCo₃ as representative phases, which makes the tensile strength, abrasion resistance, corrosion resistance, electrocatalytic performance, and thermoelectricity performance of the coating significantly improved.

The selection of process parameters in the atmospheric plasma spraying process in the present disclosure affects the thickness and the homogeneity of the resulting brake disc coating, and only strictly controlling the spraying parameters may achieve the maximum optimization of the microscopic morphology of the brake disc coating.

In some embodiments, there are micro-sensors embedded in the coating, the micro-sensors being configured to in response to the braking of the vehicle, acquire a wear signal and send the wear signal to a processor.

A micro-sensor is a sensor configured to acquire wear signals. In some embodiments, the micro-sensor may be fixed to the surface of the brake disc base in advance, and the micro-sensor embedded in the coating may be obtained after atmospheric plasma spraying.

In some embodiments, the micro-sensor is a piezoelectric film including a piezoelectric unit that detects the pressure and a shear unit that detects the shear force, the pressure being a force perpendicular to the surface of the brake disc, and the shear force being a force parallel to the surface of the brake disc.

In some embodiments, the micro-sensor further includes a temperature sensor. The temperature sensor may continuously collect temperature during vehicle braking and send the temperature to the processor. The processor constructs a temperature sequence that includes temperatures at different points in time.

The wear signal refers to an electrical signal captured by the micro-sensor when the vehicle is braked. In some embodiments, the wear signal includes a first signal captured by the piezoelectric unit and a second signal captured by the shear unit. The first signal and the second signal include a voltage and a current output by the piezoelectric unit and the shear unit, respectively, during a single vehicle braking.

In some embodiments, the processor is configured to generate coating wear data based on the wear signal via a coefficient prediction model.

The coating wear data may reflect the wear of the coating. In some embodiments, the coating wear data includes a friction coefficient of the coating surface. Because the coating has a higher friction coefficient compared to the brake disc base, the friction coefficient of the coating surface decreases significantly when the coating is worn more severely, thus the friction coefficient of the coating surface reflects the wear of the coating.

The coefficient prediction model is a prediction model for determining the coating wear data. In some embodiments, the coefficient prediction model is any one or a combination of machine learning models, e.g., deep neural networks (DNN) model or other customized model structures, etc.

In some embodiments, inputs to the coefficient prediction model include a temperature sequence, a first charge, and a second charge. Outputs of the coefficient prediction model include pressure and friction applied to the brake disc when the vehicle braking.

In some embodiments, the coefficient prediction model may be obtained by training based on a plurality of first training samples with first labels. The first training samples include a sample temperature sequence, a sample first charge, and a sample second charge, and the first labels include a sample pressure and a sample friction.

In some embodiments, the plurality of first training samples with the first labels may be obtained through simulation experiments or historical data. For example, a plurality of vehicle braking experiments may be conducted, the brake pad temperature, first charge, and second charge captured in each experiment are designated as the first training samples, and the pressure and friction applied to the brake discs as the first labels. The vehicle braking experiments may be simulation experiments or actual experiments.

In some embodiments of the present disclosure, the processor may perform the following training process to obtain the coefficient prediction model. The training process includes obtaining a plurality of first training samples with first labels to form a first set of training samples and executing a plurality of rounds of iterations based on the first set of training samples. At least one round of iteration includes selecting one or more first training samples from a training data set, inputting the one or more first training samples into an initial coefficient prediction model, obtaining one or more model prediction outputs corresponding to the first training samples; substituting the model prediction outputs corresponding to the one or more first training samples and the first labels corresponding to the one or more first training samples into a formula of a predefined loss function, calculating a value of the loss function; iteratively updating model parameters in the initial coefficient prediction model according to the value of the loss function, ending the iteration until an end-of-iteration condition is satisfied, and obtaining the trained coefficient prediction model. The model parameters in the initial coefficient prediction model may be iteratively updated by a variety of manners, e.g., iteratively updated based on the gradient descent algorithm. The end-of-iteration condition may include the loss function converging or the count of iterations reaching an iteration count threshold, or the like.

In some embodiments of the present disclosure, the processor may determine a friction coefficient of the coating based on the pressure and friction output from the coefficient prediction model. The friction coefficient of the coating is positively correlated to the pressure and negatively correlated to the friction.

For example, the processor may obtain the friction coefficient of the coating based on the following equation (1):

$$μ = \frac{{F}_{N}}{{F}_{f}} , \qquad ( 1 )$$

where μ denotes the friction coefficient of the coating, F_{N} denotes the pressure, and F_{f} denotes the friction force.

In some embodiments of the present disclosure, the coating wear data is determined by the coefficient prediction model, which may accurately sense the current wear of the coating. When the coating wear is severe, i.e., when the friction coefficient decreases significantly, it may timely remind the relevant personnel to replace the brake disc to ensure the braking effect of the brake disc and protect the safety of the vehicle when traveling.

In some embodiments, the micro-sensor is further configured to send a coating wear warning to the processor in response to the coating wear data meeting a preset warning condition.

The preset warning condition is a warning condition when severe wear and tear of the coating occurs. In some embodiments, the preset warning condition is that the friction coefficient of the coating collected for N consecutive times is less than a preset friction threshold. The count N and the preset friction threshold may be preset based on a priori experience.

In some embodiments, the preset friction threshold is related to a braking frequency of the vehicle. The braking frequency of the vehicle may reflect how many times the vehicle brakes. In some embodiments, the processor may count the historical braking times of the vehicle and determine the statistically obtained historical braking frequency as the braking frequency.

In some embodiments, the preset friction threshold is positively correlated to the braking frequency of the vehicle. The higher the braking frequency of the vehicle, the more frequently the friction of the brake disc occurs, at which point the coating wears down more severely and the effectiveness of the brake disc decreases more quickly. Therefore, it is possible to raise the preset friction threshold and invoke the anti-lock braking system (ABS) more frequently to adapt to the frequent changes in the wear data that may be present, thus improving the anti-lock effect.

In some embodiments, in response to receiving a coating wear warning, the processor may generate brake adjustment parameters and send the brake adjustment parameters to the ABS, in order to allow the ABS to apply a corresponding specific frequency and specific amplitude of braking force during a specific braking period when the vehicle is braking, based on the braking pressure.

The brake adjustment parameter is an updated brake parameter. In some embodiments, the brake adjustment parameter includes a braking time period, a braking frequency, and a braking amplitude corresponding to different braking time periods. For example, the braking time period includes an initial braking period, a middle braking period, and an end braking period. The braking frequency includes the frequency of applying pressure to the brake disc during the different braking time periods. The braking amplitude includes the magnitude of applying pressure to the brake disc during the different braking time periods.

In some embodiments, in response to receiving a coating wear warning, the processor may generate brake adjustment parameters in various ways. For example, the processor may construct a first feature vector based on the current friction coefficient of the coating, perform a vector match in a first vector database based on the first feature vector to determine a first correlation vector, and determine, based on the first correlation vector, the brake adjustment parameters.

In some embodiments, the first feature vector may be constructed in a variety of ways. For example, the first feature vector is constructed by manners such as One-Hot or Word2Vec, or the like.

The first vector database may include a plurality of first reference vectors and corresponding reference brake adjustment parameters. Each of the first reference vectors may be constructed based on historical friction coefficients of a historical coating. The first reference vectors are constructed similarly as the first feature vectors. The reference brake adjustment parameters may be historical brake adjustment parameters corresponding to the first reference vector with the best braking effect. The processor may, from historical braking records, obtain historical braking distances and historical sway amplitudes of historical vehicles and perform normalization and weighted summation, select a historical braking record with the smallest weighted summation, and set a historical brake adjustment parameter corresponding to the historical braking record to be the historical brake adjustment parameter with the best braking effect. The weighting coefficients of the historical braking distances and the historical sway amplitudes may be determined based on a priori experience.

In some embodiments, the processor may determine, by vector matching, a first reference vector that matches the vector with the highest vector similarity as the first correlation vector and determine the reference brake adjustment parameter corresponding to the first correlation vector as the currently desired brake adjustment parameter.

In some embodiments of the present disclosure, by sending the coating wear warning to the processor and generating the brake adjustment parameters to be sent to the ABS for applying a braking force corresponding to a specific frequency and a specific magnitude at a specific braking time period during braking of the vehicle, the braking effect of the vehicle may be ensured while avoiding vehicle locking to the greatest extent.

In some embodiments, the processor may also determine the powder feeding rate based on spraying parameters and preset coating parameters through a speed prediction model.

The spraying parameters are control parameters in atmospheric plasma spraying. In some embodiments, the spraying parameters include the spraying distance, the hydrogen flow rate and the argon flow rate of the plasma stream, the spraying current, the spraying voltage, the torch moving velocity, the powder feeding manner, and the number of repetitions.

The preset coating parameters are parameters to be met by the coating. In some embodiments, the preset coating parameters include a coating thickness, a coating hardness, a coating wear resistance, and a coating corrosion resistance.

The speed prediction model is a prediction model for determining the powder feeding rate. In some embodiments, the speed prediction model may be a machine learning model. For example, the speed prediction model is any one or a combination of a deep neural network (DNN) model or other customized model structures.

In some embodiments, inputs of the speed prediction model include the spraying parameters and the preset coating parameters, and outputs of the speed prediction model include the powder feeding rate.

In some embodiments, the inputs of the speed prediction model further include a particle size distribution of the high-entropy alloy powder. The particle size distribution may reflect the particle size of the high-entropy alloy powder. In some embodiments, the particle size distribution includes a range of the particle size of the high-entropy alloy powder, and a proportion of different particle sizes.

In some embodiments of the present disclosure, the particle size of the high-entropy alloy powder affects the flowability, and thus the conveyance stability of the powder feeding. For example, when the particle size of the powder is large, the inter-particle friction is small, and at this time, the powder mobility is better, thus a higher powder feeding rate is more suitable. When the powder particle size is small, agglomeration is easy to occur, and the mobility is poor, and at this time, the powder feeding rate needs to be reduced. Therefore, inputting the particle size distribution of the high-entropy alloy powder into the speed prediction model helps to improve the accuracy of the model output.

In some embodiments, the inputs of the speed prediction model further include brake disc material data. The brake disc material data may reflect material features of the brake disc. In some embodiments, the brake disc material data includes the material of the brake disc, thermal conductivity, roughness, or the like.

In some embodiments of the present disclosure, since the material data of the brake disc affects whether the coating can be tightly and firmly bonded to the brake disc, inputting the brake disc material data into the speed prediction model may help increase the accuracy of the model output. For example, when the brake disc has a high thermal conductivity and dissipates heat fast, a higher powder feeding rate is needed to avoid the coating from cooling down too quickly and resulting in poor bonding. When the brake disc has a low thermal conductivity and dissipates heat slowly, a lower powder feeding rate is needed.

In some embodiments, the inputs of the speed prediction model further include spray environment features. The spray environment features may reflect the surrounding environment during atmospheric plasma spraying. In some embodiments, the spray environment features include an environment temperature and an environment humidity when spraying.

In some embodiments of the present disclosure, since the environment temperature and the environment humidity during spraying affect whether the coating can be tightly and firmly bonded to the brake discs, for example, when the environment temperature is high, the stability of the plasma jet decreases and the powder is prone to overheat and evaporate, at which time it is necessary to reduce the powder feeding rate to prevent the coating composition from deviating. As another example, when the environment humidity is high, the surface of the high-entropy alloy powder is prone to absorbing moisture, and it is easy to agglomerate and difficult to uniformly feed the powder, at this time it is necessary to reduce the powder feeding rate. Therefore, inputting the spray environment features into the speed prediction model helps to improve the accuracy of the model output.

In some embodiments, the speed prediction model may be obtained by training based on a plurality of second training samples with second labels. The second training samples include sample spraying parameters and sample preset coating parameters, and the second labels include a sample powder feeding rate.

In some embodiments, the plurality of second training samples with the second labels may be obtained from historical data. For example, the processor may obtain a plurality of historical spraying parameters and historical preset coating parameters as the second training samples. For each of the second training samples, the processor may select the historical spraying record with the best coating quality of the historical powder feeding rate as the second label. The processor may, from the historical inspection records, obtain the impurity content, porosity, and the number of cracks of the coating after spraying is completed, normalize and then perform a weighted summation, and take the coating corresponding to the historical spraying record with the smallest weighted sum as the coating record with the best coating quality. The weighting factors of the impurity content, porosity, and number of cracks of the coating may be determined based on a priori experience.

In some embodiments of the present disclosure, by using the speed prediction model to determine the powder feeding rate, the data processing capability and the data analysis capability of the model may be fully utilized to obtain accurate and reliable prediction results in a short time, to timely and accurately regulate the powder feeding rate during atmospheric plasma spraying.

In some embodiments, when performing atmospheric plasma spraying based on the powder feeding rate, the processor may also obtain a plurality of spray images acquired by an image acquisition device at preset intervals.

The image acquisition device is a device for acquiring images of the spraying process. In some embodiments, the image acquisition device includes, but is not limited to, a high-speed camera, an infrared camera, or the like. The image acquisition device may continuously acquire spray images based on a preset period. The preset period may be preset based on a priori experience.

The spray images are images of the plasma jet and the high-entropy alloy melt droplets in it when atmospheric plasma spraying is performed on the brake disc.

Further, the processor may adjust the powder feeding rate during the next preset cycle based on the plurality of spray images.

In some embodiments, the processor extracts spray features of the spray images by an image recognition algorithm. In some embodiments, the image recognition algorithms include, but are not limited to, particle image velocimetry (PIV), image recognition model, or the like.

The spray features may reflect the property of the plasma jet and the high-entropy alloy melt droplets therein. In some embodiments, the spray features include temperature field distributions, velocities, trajectories, and a count of clusters in the plasma jet of the high-entropy alloy melt droplets. The temperature field distribution may reflect a temperature distribution of the high-entropy alloy molten droplets in the plasma jet. The trajectory may reflect a trajectory of the movement of the high-entropy alloy molten droplets in the plasma jet. The count of clusters may reflect the count of particles that are aggregated into clusters in the plasma jet.

In some embodiments, the processor recognizes the spray images acquired by the infrared camera through the image recognition model to obtain the temperature field distribution of the high-entropy alloy melt droplets, and recognizes the spray images acquired by the high-speed camera through particle image velocimetry to obtain the velocity and trajectory of the high-entropy alloy melt droplets and the count of clusters in the plasma jet.

In some embodiments, the processor constructs a second feature vector based on the spray features, performs vector matching in a second vector database based on the second feature vector to determine a second correlation vector, and determines, based on the second correlation vector, a powder feeding rate in the next preset cycle.

In some embodiments, the second feature vector may be constructed in a variety of ways. For example, the second feature vector is constructed by manners such as One-Hot, Word2Vec, or the like.

The second vector database may include a plurality of second reference vectors and corresponding reference powder feeding rates. Each of the second reference vectors may be constructed based on a historical spray feature, and the processor may determine the historical spray feature based on the historical spray image by an image recognition algorithm. The second reference vectors are constructed similarly as the second feature vectors. The reference powder feeding rate may be the historical powder feeding rate at which the second reference vector has the best coating quality in the time period corresponding to the next preset cycle. The processor may, from the historical inspection record, obtain the impurity content, porosity, and a count of cracks of the coating after the spraying is completed, normalize and then perform a weighted summation, and treat the historical spraying record corresponding to the coating with the smallest weighted sum as the historical coating record with the best coating quality. The weighting factors of the impurity content, the porosity, and the count of cracks of the coating may be determined based on a priori experience.

In some embodiments, the processor may determine, by vector matching, a second reference vector that matches the vector with the highest vector similarity as a second correlation vector and determine the second correlation vector corresponding to the reference powder feeding rate, as the powder feeding rate in the next preset cycle.

In some embodiments of the present disclosure, by adjusting the powder feeding rate in the next preset cycle by the spray image, the quality of the current atmospheric plasma spraying may be detected in real time. When an abnormality in spraying occurs, the powder feeding rate in the next preset cycle may be adjusted in time, thus ensuring the smooth and reliable operation of spraying and obtaining high quality coating.

In some embodiments of the present disclosure, the method for preparing the brake disc coating includes the following operations (1)-(3).

In operation (1), the Al powder, the Co powder, the Ni powder, the Cu powder, and the Ti powder are mixed based on the molar ratio, then subjected to gas atomization. After sieving, a high-entropy alloy powder with a particle size in a range of 25-75 μm was obtained. The gas atomization includes under the protection of the inert gas, performing repeated melting on the Co powder, the Ni powder, the Cu powder, and the Ti powder with purities all larger than or equal to 99.9% for 3-5 times until molten droplets fall, then performing high-pressure atomization using argon. The vacuum degree during the gas atomization is in a range of 2.5×10⁻⁴-3.5×10⁻⁴ Pa, the melting power is in a range of 30-40 kW, and the pressure of the high-pressure atomization is in a range of 7.5-8.5 MPa

In operation (2), the high-entropy alloy powder obtained in operation (1) is preheated to obtain the standby alloy powder. The preheating is at a temperature of 180-230° C. for 150-200 min.

In operation (3), the atmospheric plasma spraying is performed on the surface of the brake disc base after pre-treatment using the standby alloy powder as the spraying material, to obtain the brake disc coating with a thickness in a range of 200-300 μm. The pre-treatment includes sequentially performing sandblasting pre-treatment, cleaning, and drying on the surface of the brake disc base. The sandblasting material used in the sandblasting pre-treatment includes a brown fused alumina sand, and the compressed air pressure in the sandblasting pre-treatment is in a range of 0.3-0.8 MPa. The angle between the spray gun and the surface of the brake disc base in the sandblasting pre-treatment is in a range of 40-50°. The cleaning treatment includes using a degreaser for cleaning treatment.

In the atmospheric plasma spraying, the spraying distance is in a range of 100-150 mm, the argon flow rate is in a range of 30-50 L/min, the hydrogen flow rate in the plasma gas stream is in a range of 3-6 L/min, the spraying current is in a range of 480-550 A, the spraying voltage is in a range of 50-60 V, the torch moving velocity is in a range of 150-400 mm/s, the spraying spacing is 3 mm, the powder feeding rate is in a range of 2-10 g/min, the powder feeding manner includes vertical jet powder feeding, and repeated passes are in a range of 4-6 times.

The range of values described in the present disclosure includes not only the point values enumerated above, but also any point values not enumerated between the above ranges of values and limited to space and for the sake of simplicity, the present disclosure is not exhaustive in enumerating the specific point values included in the range.

The technical solutions of the present disclosure are further described below in conjunction with the accompanying drawings and by way of specific embodiments. It should be clear to those skilled in the art that the described embodiments are merely an aid to understanding the present disclosure and should not be regarded as specific limitations of the present disclosure.

In the friction and wear test of the following embodiment and the proportionally provided coatings, the grinding ball is a GCr 15 steel ball, the load is 10 N, the frequency is 4 Hz, the length of the abrasion mark is 5 m, and the total sliding distance is 100 m. The corrosion behavior in seawater (3.5% NaCl solution) was simulated using a CHI 604E electrochemical workstation for the alloy coating in the corrosion testing of the following embodiments and comparative examples.

### Embodiment 1

The present embodiment provides a brake disc coating, the preparation material of the brake disc coating is high-entropy alloy powder, and a method for preparing the brake disc coating includes the following operations (1)-(3).

In operation (1), the Al powder, the Co powder, the Ni powder, the Cu powder, and the Ti powder were mixed based on the molar ratio 1:1:1:1:1, then subjected to gas atomization. After sieving, a high-entropy alloy powder with particle size of 50-60 μm and with a single BCC crystal structure was obtained. The gas atomization includes under inert gas protection, repeated melting was performed on the Co powder, the Ni powder, the Cu powder, and the Ti powder with purities all larger than or equal to 99.9% for 4 times until molten droplets fall, then high-pressure atomization was performed using argon. The vacuum degree during the gas atomization was 3×10⁻⁴ Pa, the melting power was 40 kW, and the pressure of the high-pressure atomization was 8 MPa.

In operation (2), the high-entropy alloy powder obtained in operation (1) was preheated to obtain the standby alloy powder. The preheating temperature was in a range of 200° C., and the preheating time was in a range of 180 min.

In operation (3), the atmospheric plasma spraying was performed on the surface of the brake disc base after pre-treatment using the standby alloy powder as the spraying material, to obtain the brake disc coating with a thickness of 287 μm and a hardness of 309 HV_{0.1}. The pre-treatment includes sequentially performing sandblasting pre-treatment, cleaning, and drying on the surface of the brake disc base. In the sandblasting pre-treatment, the sandblasting material was 20# brown fused alumina sand, the compressed air pressure was 0.5 MPa, and the angle between the spray gun and the surface of the brake disc base was 45°. The cleaning includes using the degreaser for cleaning treatment. In the atmospheric plasma spraying, the spraying distance was 100 mm, the hydrogen flow rate of the plasma gas flow was 6 L/min, the argon flow rate was 40 L/min, the spraying current was 519 A, the spraying voltage was 55 V, the troch moving velocity was 200 mm/s, the spraying spacing was 3 mm, the powder feeding rate was 2.5 g/min, the powder feeding manner includes vertical jet powder feeding, and number of repetitions were 5 times.

### Embodiment 2

The present embodiment provides a brake disc coating, the preparation material of the brake disc coating is high-entropy alloy powder, and a method for preparing the brake disc coating includes the following operations (1)-(3).

In operation (1), the Al powder, the Co powder, the Ni powder, the Cu powder, and the Ti powder were mixed based on the molar ratio 1:1:1:1:1:0.7, then subjected to gas atomization. After sieving, a high-entropy alloy powder with particle size of 30-70 μm and with a single BCC crystal structure was obtained. The gas atomization includes under inert gas protection, repeated melting was performed on the Co powder, the Ni powder, the Cu powder, and the Ti powder with purities all larger than or equal to 99.9% for 3 times until molten droplets fall, then high-pressure atomization was performed using argon. The vacuum degree during the gas atomization was 3.5×10⁻⁴ Pa, the melting power was 40 kW, and the pressure of the high-pressure atomization was 7.5 MPa.

In operation (2), the high-entropy alloy powder obtained in operation (1) was preheated to obtain the standby alloy powder. The preheating temperature was in a range of 180° C., and the preheating time was in a range of 200 min.

In operation (3), the atmospheric plasma spraying was performed on the surface of the brake disc base after pre-treatment using the standby alloy powder as the spraying material, to obtain the brake disc coating with a thickness of 213 μm and a hardness of 257 HV_{0.1}. The pre-treatment includes sequentially performing sandblasting pre-treatment, cleaning, and drying on the surface of the brake disc base. In the sandblasting pre-treatment, the sandblasting material was 20# brown fused alumina sand, the compressed air pressure was 0.3 MPa, and the angle between the spray gun and the surface of the brake disc base was 40°. The cleaning includes using the degreaser for cleaning treatment. In the atmospheric plasma spraying, the spraying distance was 150 mm, the hydrogen flow rate of the plasma gas flow was 3 L/min, the argon flow rate was 50 L/min, the spraying current was 550 A, the spraying voltage was 60 V, the torch moving velocity was 150 mm/s, the spraying spacing was 3 mm, the powder feeding rate was 2 g/min, the powder feeding manner includes vertical jet powder feeding, and number of repetitions were 4 times.

### Embodiment 3

The present embodiment provides a brake disc coating, the preparation material of the brake disc coating is high-entropy alloy powder, and a method for preparing the brake disc coating includes the following operations (1)-(3).

In operation (1), the Al powder, the Co powder, the Ni powder, the Cu powder, and the Ti powder were mixed based on the molar ratio 1:1:1:1:1:1.3, then subjected to gas atomization. After sieving, a high-entropy alloy powder with particle size of 25-75 μm and with a single BCC crystal structure was obtained. The gas atomization includes under inert gas protection, repeated melting was performed on the Co powder, the Ni powder, the Cu powder, and the Ti powder with purities all larger than or equal to 99.9% for 5 times until molten droplets fall, then high-pressure atomization was performed using argon. The vacuum degree during the gas atomization was 2.5x10⁻⁴ Pa, the melting power was 30 kW, and the pressure of the high-pressure atomization was 8.5 MPa.

In operation (2), the high-entropy alloy powder obtained in operation (1) was preheated to obtain the standby alloy powder. The preheating temperature was in a range of 230° C., and the preheating time was in a range of 150 min.

In operation (3), the atmospheric plasma spraying was performed on the surface of the brake disc base after pre-treatment using the standby alloy powder as the spraying material, to obtain the brake disc coating with a thickness of 293 μm and a hardness of 321 HV_{0.1}. The pre-treatment includes sequentially performing sandblasting pre-treatment, cleaning, and drying on the surface of the brake disc base. In the sandblasting pre-treatment, the sandblasting material was 20# brown fused alumina sand, the compressed air pressure was 0.8 MPa, and the angle between the spray gun and the surface of the brake disc base was 50°. The cleaning includes using the degreaser for cleaning treatment. In the atmospheric plasma spraying, the spraying distance was 120 mm, the hydrogen flow rate of the plasma gas flow was 4.6 L/min, the argon flow rate was 30 L/min, the spraying current was 480 A, the spraying voltage was 50 V, the torch moving velocity was 400 mm/s, the spraying spacing was 3 mm, the powder feeding rate was 10 g/min, the powder feeding manner includes vertical jet powder feeding, and number of repetitions were 6 times.

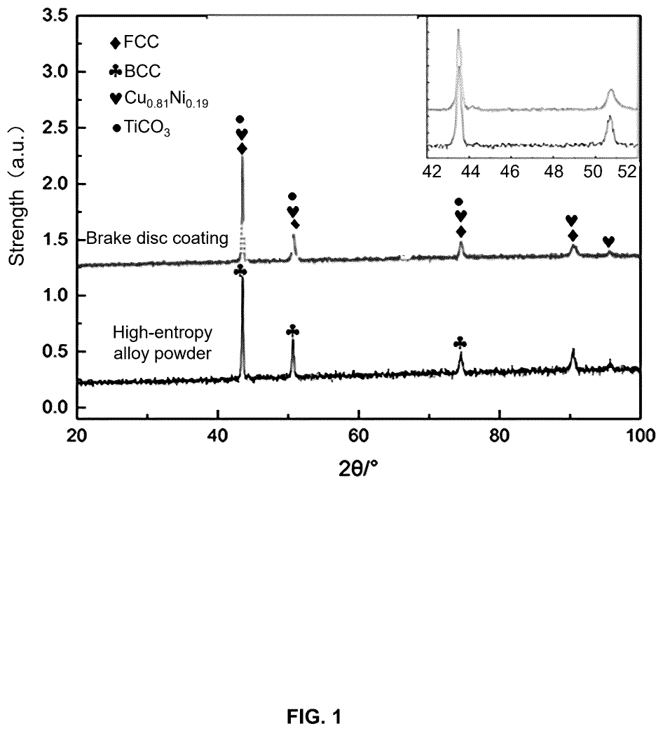

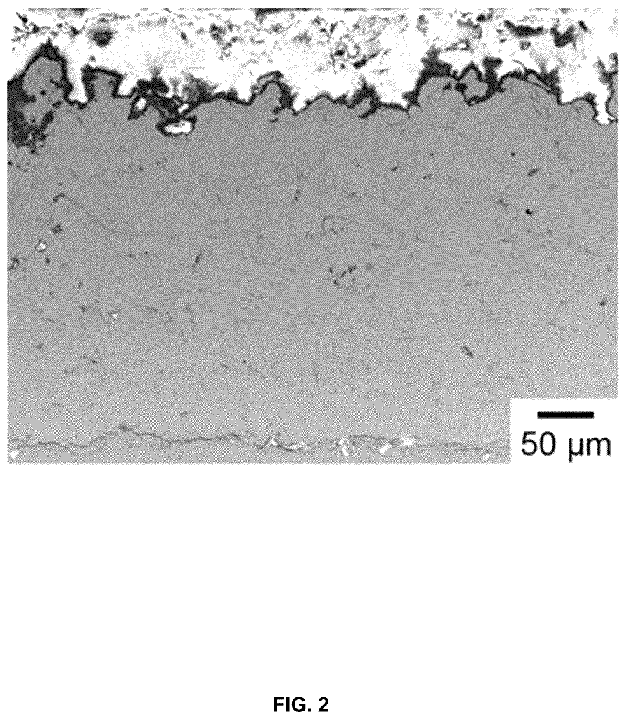

The XRD patterns of the high-entropy alloy powder and the brake disc coating of embodiment 3 are shown in FIG. 1. The cross-sectional SEM image of the brake disc coating of embodiment 3 is shown in FIG. 2. As shown in FIG. 1, the XRD patterns of the high-entropy alloy powder and the brake disc coating of embodiment 3 indicate that after atmospheric plasma spraying, the crystal phase of the brake disc coating changes from a loosely arranged BCC structure to a tightly arranged FCC structure. This transformation enhances the atomic bonding force within the brake disc coating, thereby ensuring its wear-resistant performance. Moreover, sharp peaks may be observed in FIG. 1, indicating that the brake disc coating prepared by atmospheric plasma spraying exhibits high crystallinity with almost no defects. As shown in FIG. 2, the cross-sectional SEM image of the brake disc coating of embodiment 3 reveals that the coating has a dense microstructure without evident pores or cracks. The porosity is as low as 1.03%, demonstrating that the brake disc coating has an intact structure.

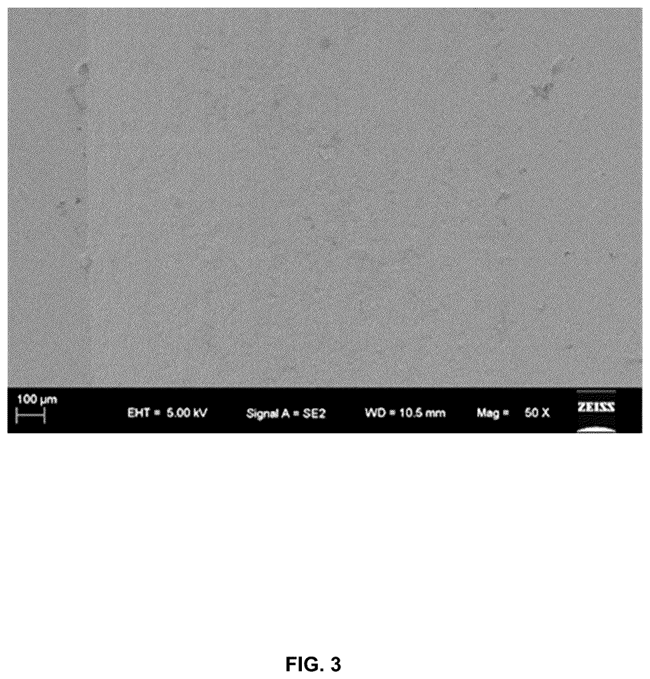

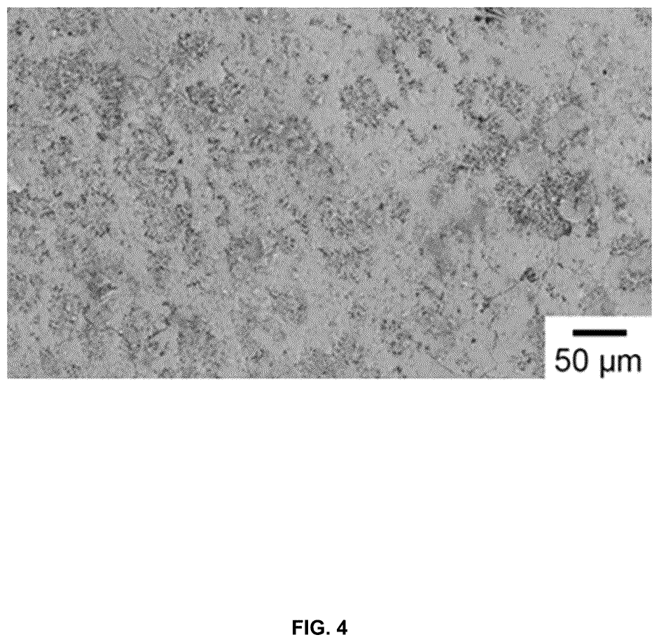

The SEM image of the brake disc coating surface after friction testing and the SEM image of the coating surface after corrosion testing of the coating of the embodiment 3 are shown in FIG. 3 and FIG. 4, respectively. According to FIG. 3, the brake disc coating of the embodiment 3, after friction, has a fairly smooth friction surface accompanied by several small pits. The abrasion marks are very shallow, making it difficult to differentiate the abrasion marks from the substrate, and the abrasion resistance is excellent. According to FIG. 4, it is evident that the surface of the brake disc coating of the embodiment 3 is relatively flat after corrosion, the accumulation of corrosion products is minimal, and there are only a few small corrosion pits with fewer holes and shallow corrosion depth, indicating that its corrosion resistance is well.

The results of the friction testing and the corrosion testing of the brake disc coating of embodiments 1-3 above are shown in table 1.

TABLE 1

| | | | Corrosion testing | |
|---|---|---|---|---|
| | | | Self- | |
| | | | corrosion | Self- |
| | Friction testing | | current | corrosion |
| | Friction | Wear rate | density | potential |
| | coefficient | (mm³/N · m) | (A/cm²) | (mV) |
| Embodiment 1 | 0.74 | 3.56 × 10⁻⁴ | 3.62 × 10⁻⁶ | −600.1 |
| Embodiment 2 | 0.69 | 5.11 × 10⁻⁴ | 3.78 × 10⁻⁶ | −583.2 |
| Embodiment 3 | 0.79 | 3.32 × 10⁻⁴ | 3.43 × 10⁻⁶ | −621.3 |

From analysing table 1, it may be seen that the brake disc coating provided by the present disclosure has superior wear and corrosion resistance properties. The brake disc coating of the embodiment 3 has optimal wear and corrosion resistance properties.

The following embodiment investigates the effect of coating thickness on the performance of the brake disc coating.

### Embodiment 4

The present embodiment provides a brake disc coating, the preparation material of the brake disc coating is the high-entropy alloy powder. The operations for preparing the brake disc coating in embodiment 4 are similar to those of embodiment 3, with the difference being that in the atmospheric plasma spraying in operation (3), the spraying distance was modified to 110 mm, the hydrogen flow rate of the plasma gas stream was modified to 3 L/min, and the thickness of the brake disc coating obtained by the present embodiment was 275 μm.

### Embodiment 5

The present embodiment provides a brake disc coating, the preparation material of the brake disc coating is the high-entropy alloy powder. The operations for preparing the brake disc coating in embodiment 5 are similar to those of embodiment 3, with the difference being that in the atmospheric plasma spraying in operation (3), the spraying distance was modified to 130 mm, the hydrogen flow rate of the plasma gas stream was modified to 4 L/min, and the thickness of the brake disc coating obtained by the present embodiment was 269 μm.

### Embodiment 6

The present embodiment provides a brake disc coating, the preparation material of the brake disc coating is the high-entropy alloy powder. The operations for preparing the brake disc coating in embodiment 6 are similar to those of embodiment 3, with the difference being that in the atmospheric plasma spraying in operation (3), the spraying distance was modified to 150 mm, the hydrogen flow rate of the plasma gas stream was modified to 5 L/min, and the thickness of the brake disc coating obtained by the present embodiment was 253 μm.

### Embodiment 7

The present embodiment provides a brake disc coating, the preparation material of the brake disc coating is the high-entropy alloy powder. The operations for preparing the brake disc coating in embodiment 7 are similar to those of embodiment 3, with the difference being that in the atmospheric plasma spraying in operation (3), the spraying distance was modified to 200 mm, the hydrogen flow rate of the plasma gas stream was modified to 5.5 L/min, and the thickness of the brake disc coating obtained by the present example was 190 μm.

### Embodiment 8

The present embodiment provides a brake disc coating, the preparation material of the brake disc coating is the high-entropy alloy powder. The operations for preparing the brake disc coating in embodiment 8 are similar to those of embodiment 3, with the difference being that in the atmospheric plasma spraying in operation (3), the spraying distance was modified to 95 mm, the hydrogen flow rate of the plasma gas stream was modified to 6.5 L/min, and the thickness of the brake disc coating obtained by the present example was 305 μm.

The results of the friction testing and the corrosion testing on the brake disc coating of the embodiment 3 and embodiments 4-8 above are shown in table 2.

TABLE 2

| | | | | Corrosion testing | |
|---|---|---|---|---|---|
| | | | | Self- | |
| | | | | corrosion | Self- |
| | Coating | Friction testing | | current | corrosion |
| | thickness | Friction | Wear rate | density | potential |
| | (μm) | coefficient | (mm³/N · m) | (A/cm²) | (mV) |
| Embodiment 3 | 293 | 0.79 | 3.32 × 10⁻⁴ | 3.43 × 10⁻⁶ | −621.3 |
| Embodiment 4 | 275 | 0.75 | 4.32 × 10⁻⁴ | 3.68 × 10⁻⁶ | −591.6 |
| Embodiment 5 | 269 | 0.78 | 4.83 × 10⁻⁴ | 3.87 × 10⁻⁶ | −567.3 |
| Embodiment 6 | 253 | 0.71 | 4.93 × 10⁻⁴ | 4.43 × 10⁻⁶ | −511.5 |
| Embodiment 7 | 190 | 0.62 | 5.36 × 10⁻⁴ | 5.16 × 10⁻⁶ | −473.1 |
| Embodiment 8 | 305 | 0.78 | 3.14 × 10⁻⁴ | 3.48 × 10⁻⁶ | −613.4 |

From analyzing embodiments 3-6 according to table 2, it may be seen that when the coating thicknesses are between 250 and 300 μm, the coatings for the brake discs all have superior abrasion and corrosion resistance properties, and embodiment 3 has the highest coating thickness, which provides coatings with optimal wear and corrosion resistance properties. It may be seen that the higher the coating thickness, the better the wear and corrosion resistance.

However, from analyzing embodiment 3 and embodiment 8, it may be seen that when the thickness of the coating is excessively large, the abrasion and corrosion resistance of the coating does not continue to be improved. From analyzing embodiment 6 and embodiment 7, it may be seen that when the thickness of the coating is excessively small, the abrasion rate and the self-corrosive current density increase significantly.

The present disclosure therefore requires strict control of the thickness of the brake disc coating, to provide superior wear and corrosion resistance.

The following embodiment investigates the effect of the particle size of the high-entropy alloy powder on the properties of the brake disc coating.

### Embodiment 9

The present embodiment provides a brake disc coating, and the preparation material of the brake disc coating is high-entropy alloy powder. The operations for preparing the brake disc coating in embodiment 9 are similar to those of embodiment 3, with the difference being that the particle size of the high-entropy alloy powder obtained by gas atomization in operation (1) was modified to be in a range of 80-90 μm.

### Embodiment 10

The present embodiment provides a brake disc coating, the preparation material of the brake disc coating is high-entropy alloy powder. The operations for preparing the brake disc coating in embodiment 10 are similar to those of embodiment 3, with the difference being that the particle size of the high-entropy alloy powder obtained by gas atomization in operation (1) was modified to be in a range of 25-40 μm.

### Embodiment 11

The present embodiment provides a brake disc coating, the preparation material of the brake disc coating is high-entropy alloy powder. The operations for preparing the brake disc coating in embodiment 11 are similar to those of embodiment 3, with the difference being the particle size of the high-entropy alloy powder obtained by gas atomization in operation (1) was modified to be less than or equal to 10 μm.

The results of the friction testing and the corrosion testing for the brake disc coating of the embodiment 3 and embodiments 9-11 above are shown in table 3.

TABLE 3

| | | | | Corrosion testing | |
|---|---|---|---|---|---|
| | Particle | | | Self- | |
| | size of | | | corrosion | Self- |
| | high-entropy | Friction testing | | current | corrosion |
| | alloy powder | Friction | Wear rate | density | potential |
| | (μm) | coefficient | (mm³/N · m) | (A/cm²) | (mV) |
| Embodiment 3 | 25-75 | 0.79 | 3.32 × 10⁻⁴ | 3.43 × 10⁻⁶ | −621.3 |
| Embodiment 9 | 80-90 | 0.78 | 4.14 × 10⁻⁴ | 3.98 × 10⁻⁶ | −532.2 |
| Embodiment 10 | 25-40 | 0.69 | 3.01 × 10⁻⁴ | 3.23 × 10⁻⁶ | −655.2 |
| Embodiment 11 | ≤10 | 0.77 | 3.85 × 10⁻⁴ | 3.86 × 10⁻⁶ | −549.7 |

Analysis of table 3 shows that the selection of the particle size of the high-entropy alloy powder in the preparation method of the the present disclosure affects the abrasion and corrosion resistance properties of the brake disc coatings.

Analyzing embodiment 3 and embodiment 9, it is shown that when the particle size of the selected high-entropy alloy powder is too large, the wear and corrosion resistance of the brake disc coatings are reduced. From analyzing embodiment 3 and embodiment 10, it may be seen that when the particle size of the selected high-entropy alloy powder is further reduced, the wear resistance and corrosion resistance properties are slightly improved, the wear rate, self-corrosion current density and self-corrosion potential change is small, which is because the preparation material powder with a fine particle size has a higher speed and temperature in the spraying process, resulting in a stronger coating density, smaller surface porosity, fewer boundary defects, and superior wear resistance. However, if the size of the preparation material is too small (as in embodiment 11), the fracture toughness of the coating may be affected, and the smaller the particle size, the more complicated the powdering process, and the higher the cost. Thus, a suitable particle size is selected to optimize the overall performance.

The following embodiments investigate the effect of the process on the properties of the brake disc coating.

### Embodiment 12

The present embodiment provides a brake disc coating, and the preparation material of the brake disc coating is high-entropy alloy powder. The operations for preparing the brake disc coating in embodiment 12 are similar to those of embodiment 3, with the difference being that the gas atomization described in operation (1) was modified to ball milling and mechanical alloying treatment carried out sequentially.

The results of the friction testing and the corrosion testing for the brake disc coating of the embodiment 3 and embodiment 12 above are shown in table 4.

TABLE 4

| | | | Corrosion testing | |
|---|---|---|---|---|
| | | | Self- | |
| | | | corrosion | Self- |
| | Friction testing | | current | corrosion |
| | Friction | Wear rate | density | potential |
| | coefficient | (mm³/N · m) | (A/cm²) | (mV) |
| Embodiment 3 | 0.79 | 3.32 × 10⁻⁴ | 3.43 × 10⁻⁶ | −621.3 |
| Embodiment 12 | 0.75 | 3.54 × 10⁻⁴ | 3.58 × 10⁻⁶ | −594.4 |

From analyzing table 4, it may be seen that compared to embodiment 3, the wear and corrosion resistance properties of the coating of the embodiment 12 are reduced. It may be seen that the gas atomization of the present disclosure is more capable of ensuring the fluidity of the powder during the spraying process and thus ensuring the uniformity of the coating and the bonding force with the metal compound, in order to achieve the purpose of enhancing the abrasion and corrosion resistance of the coating.

The following embodiment investigates the effect of the ratio of high-entropy alloy powder elements on the properties of the brake disc coating.

### Comparative Example 1

This comparative example provides a brake disc coating, and the preparation material of the brake disc coating is high-entropy alloy powder. The operations for preparing the brake disc coating in comparative example 1 are similar to those of embodiment 3, with the difference being that the molar ratio of metal elements Al, Co, Ni, Cu, and Ti in the high-entropy alloy powder described in operation (1) was modified to 1:1:1:1:0.5.

### Comparative Example 2

This comparative example provides a brake disc coating, the preparation material of the brake disc coating is a high-entropy alloy powder. The operations for preparing the brake disc coating in comparative example 1 are similar to those of embodiment 3, with the difference being that the molar ratio of the metal elements Al, Co, Ni, Cu, and Ti in the high-entropy alloy powder referred to in operation (1) was modified to 1:1:1:1:1.5.

The results of the friction testing and the corrosion testing for the brake disc coating of the embodiment 3 and comparative examples 1-2 above are shown in table 5.

TABLE 5

| | | | Corrosion testing | |
|---|---|---|---|---|
| | | | Self- | |
| | | | corrosion | Self- |
| | Friction testing | | current | corrosion |
| | Coefficient | Wear rate | density | potential |
| | of friction | (mm³/N · m) | (A/cm²) | (mV) |
| Embodiment 3 | 0.79 | 3.32 × 10⁻⁴ | 3.43 × 10⁻⁶ | −621.3 |
| Comparative | 0.79 | 4.56 × 10⁻⁴ | 3.15 × 10⁻⁶ | −663.2 |
| example1 | | | | |
| Comparative | 0.71 | 2.99 × 10⁻⁴ | 4.32 × 10⁻⁶ | −526.8 |
| example 2 | | | | |

The molar ratio of metal elements in the alloy powders of comparative examples 1 and 2 do not satisfy the requirement of high-entropy. Ti powder content in the alloy powder of the comparative example 1 is significantly reduced, and compared to embodiment 3, its corrosion resistance is improved, but its wear resistance is also significantly reduced. The alloy powder of comparative example 2 has a significantly higher content of Ti powder and has reduced wear and corrosion resistance compared to embodiment 3 (and its self-corrosion potential is only 85% of that of the coating of the embodiment 3). Therefore, the present disclosure needs to strictly control the content of each metal element in the high-entropy alloy powder in order to make the brake disc coating have superior wear and corrosion resistance.

The following comparative examples study the effect of the type of high-entropy alloy powder on the properties of the brake disc coating.

### Comparative Example 3

This comparative example provides a brake disc coating, and the preparation material of the brake disc coating is high-entropy alloy powder. The operations for preparing the brake disc coating in comparative example 3 are similar to those of embodiment 3, with the difference being that the preparation materials of the high-entropy alloy powder of the operation (1) were modified to Al powder, Co powder, Ni powder, Cu powder, Ti powder, and Zr powder, and the molar ratio of the metal elements Al, Co, Ni, Cu, Ti, and Zr was 1:1:1:1:1:1.

### Comparative Example 4

This comparative example provides a brake disc coating, and the preparation material of the brake disc coating is high-entropy alloy powder. The operations for preparing the brake disc coating in comparative example 4 are similar to those of embodiment 3, with the difference being that the preparation materials of the high-entropy alloy powder of operation (1) were modified to Al powder, Co powder, Ni powder, Cr powder, Ti powder, and Si powder, and the molar ratio of metal elements Al, Co, Ni, Cr, Ti, and Si was 1:1:1:1:1.

### Comparative Example 5

This comparative example provides a brake disc coating, and the preparation material of the brake disc coating is high-entropy alloy powder. The operations for preparing the brake disc coating in comparative example 5 are similar to those of embodiment 3, with the difference being that the preparation materials of the high-entropy alloy powder of operation (1) were modified to Al powder, Co powder, Ni powder, and Cu powder, and the molar ratio of the metal elements Al, Co, Ni, and Cu was 1:1:1:1.

### Comparative Example 6

This comparative example provides a brake disc coating, and the preparation material of the brake disc coating is high-entropy alloy powder. The operations for preparing the brake disc coating in comparative example 6 are similar to those of embodiment 3, with the difference being that the preparation materials of the high-entropy alloy powder of operation (1) were modified to Al powder, Co powder, Ni powder, Cu powder and Cr powder, and the molar ratio of the metal elements Al, Co, Ni, Cu and Cr was 1:1:1:1:1.

### Comparative Example 7

This comparative example provides a brake disc coating, and the preparation material of the brake disc coating is high-entropy alloy powder. The operations for preparing the brake disc coating in comparative example 7 are similar to those of embodiment 3, with the difference being that the preparation materials of the high-entropy alloy powder of operation (1) were modified to Al powder, Co powder, Ni powder, Cu powder, Ti powder and Cr powder, and the molar ratio of the metal elements Al, Co, Ni, Cu, Ti and Cr was 1:1:1:1:1:1.

The results of the friction testing and the corrosion testing for the brake disc coating of embodiment 3 and comparative examples 3-7 above are shown in table 6.

TABLE 6

| | | | Corrosion testing | |
|---|---|---|---|---|
| | | | Self- | |
| | | | corrosion | Self- |
| | Friction testing | | current | corrosion |
| | Friction | Wear rate | density | potential |
| | coefficient | (mm³/N · m) | (A/cm²) | (mV) |
| Embodiment 3 | 0.79 | 3.32 × 10⁻⁴ | 3.43 × 10⁻⁶ | −621.3 |
| Comparative | 0.72 | 3.49 × 10⁻⁴ | 5.21 × 10⁻⁶ | −495.8 |
| example 3 | | | | |
| Comparative | 0.69 | 3.01 × 10⁻⁴ | 5.29 × 10⁻⁶ | −493.1 |
| example 4 | | | | |
| Comparative | 0.81 | 5.07 × 10⁻⁴ | 6.69 × 10⁻⁶ | −395.2 |
| example 5 | | | | |
| Comparative | 0.75 | 4.06 × 10⁻⁴ | 5.61 × 10⁻⁶ | −483.7 |
| example 6 | | | | |
| Comparative | 0.83 | 3.74 × 10⁻⁴ | 3.65 × 10⁻⁶ | −598.8 |
| example 7 | | | | |

Compared to embodiment 3, the high-entropy alloy powder of comparative example 3 is increased with Zr powder, and the increase of Zr powder slightly enhances the abrasion resistance of the alloy coating but leads to a significant decrease in the corrosion resistance of the coating (the corrosion testing results of the surface self-corrosion current density reaches 1.5 times that of the coating of the embodiment 3, and the self-corrosion potential is only ⅘ of that of the coating of the embodiment 3).

Compared with embodiment 3, the high-entropy alloy powder of comparative example 4 is increased with Si powder, and the increase of Si powder made its wear rate slightly lower than that of embodiment 3, but its corrosion testing results of the surface self-corrosion current density reached 1.5 times that of the coating of the embodiment 3, and the self-corrosion potential is only ⅘ of the coating of the embodiment 3, with corrosion resistance significantly lower compared to embodiment 3.

Compared to embodiment 3, the high-entropy alloy powder of comparative example 5 lacks Ti powder. Because metal Ti has properties such as high strength and corrosion resistance, the absence of Ti powder results in a substantially decreasing in the lower wear resistance and corrosion resistance of the alloy.

Compared to embodiment 3, the replacement of Ti powder with Cr powder in the high-entropy alloy powder of comparative example 6 improves the wear and corrosion resistance compared to comparative example 5. However, the addition of Cr powder does not have the same effect as that of the addition of Ti powder, which indicates that the addition of Ti powder is more beneficial for obtaining the wear resistance and corrosion resistance of the alloy of the present disclosure.

Compared with embodiment 3, the high-entropy alloy powder of comparative example 7 is increased with Cr powder. It is known to those skilled in the art that metal Cr has superior corrosion resistance properties, but analysis of embodiment 3 and comparative example 7 indicates that although the corrosion-resistant Cr powder is added, the corrosion resistance of the brake disc coating does not reach the effect of embodiment 3, indicating that the addition of Cr powder affects the corrosion resistance of the brake disc coating.

Therefore, the present disclosure requires strict control of the types of elements in the high-entropy alloy powder to ensure that the brake disc coating has superior wear and corrosion resistance.

The applicant declares that the foregoing is only a specific embodiment of the present disclosure, but the scope of protection of the present disclosure is not limited thereto. Any changes or substitutions readily conceived by a person skilled in the art within the technical field disclosed in the present disclosure fall within the scope of protection and disclosure of the present disclosure.

1. A brake disc coating, wherein
the coating is prepared from high-entropy alloy powder,
a preparation raw material of the high-entropy alloy powder includes aluminum (Al) powder, cobalt (Co) powder, nickel (Ni) powder, copper (Cu) powder, and titanium (Ti) powder,
a molar ratio of metal elements Al, Co, Ni, Cu, and Ti in the high-entropy alloy powder is in a range of 1:1:1:1:(1.1-1.3), and
the high-entropy alloy powder has a single body-centered cubic (BCC) crystal structure.

2. The brake disc coating of claim 1, wherein a particle size of the high-entropy alloy powder is in a range of 25-75 μm, and a purity of the Al powder, the Co powder, the Ni powder, the Cu powder, and the Ti powder is all larger than or equal to 99.9%.

3. The brake disc coating of claim 1, wherein a thickness of the brake disc coating is in a range of 200-300 μm.

4. The brake disc coating of claim 3, wherein the thickness of the brake disc coating is in a range of 250-300 μm.

5. A method for preparing [[a]] the brake disc coating of claim 1, comprising:
(1) mixing the Al powder, the Co powder, the Ni powder, the Cu powder, and the Ti powder based on the molar ratio, then performing gas atomization and sieving, to obtain the high-entropy alloy powder;
(2) preheating the high-entropy alloy powder obtained in operation (1) to obtain a standby alloy powder; and
(3) performing atmospheric plasma spraying on a surface of a brake disc base after pre-treatment using the standby alloy powder as a spraying material, to obtain the brake disc coating.

6. The method of claim 5, wherein the gas atomization in operation (1) includes: under inert gas protection, performing repeated melting on the Al powder, the Co powder, the Ni powder, the Cu powder, and the Ti powder until molten droplets fall, then performing high-pressure atomization.

7. The method of claim 6, wherein a vacuum degree during the gas atomization is in a range of 2.5×10⁻⁴-3.5×10⁻⁴ Pa, a melting power is in a range of 30-40 kW, a number of repeated melting cycles is in a range of 3-5 times, a gas used for the high-pressure atomization includes argon, and a pressure of the high-pressure atomization is in a range of 7.5-8.5 MPa.

8. The method of claim 5, wherein in operation (2), a preheating temperature is in a range of 180-230° C., and a preheating time is in a range of 150-200 min.

9. The method of claim 5, wherein the pre-treatment in operation (3) includes sequentially performing sandblasting pre-treatment, cleaning, and drying on the surface of the brake disc base.

10. The method of claim 9, wherein a sandblasting material used in the sandblasting pre-treatment includes a brown fused alumina sand.

11. The method of claim 10, wherein a particle size of the brown fused alumina sand is any one or a combination of at least two of 16#, 18#, 20#, 22#, or 24#.

12. The method of claim 9, wherein a compressed air pressure in the sandblasting pre-treatment is in a range of 0.3-0.8 MPa.

13. The method of claim 9, wherein an angle between a spray gun and the surface of the brake disc base in the sandblasting pre-treatment is in a range of 40-50°.

14. The method of claim 9, wherein the cleaning includes using a degreaser for cleaning treatment.

15. The method of claim 5, wherein a material of the brake disc base is cast iron.

16. The method of claim 5, wherein in the atmospheric plasma spraying of operation (3),
a spraying distance is in a range of 100-150 mm,
a torch moving velocity is in a range of 150-400 mm/s,
a spraying spacing is 3 mm, and
repeated passes are in a range of 4-6 times.

17. The method of claim 5, wherein in the atmospheric plasma spraying of operation (3),
an argon flow rate is in a range of 30-50 L/min, and
a hydrogen flow rate in a plasma gas stream is in a range of 3-6 L/min.

18. The method of claim 5, wherein in the atmospheric plasma spraying of operation (3),
a spraying current is in a range of 480-550 A, and
a spraying voltage is in a range of 50-60 V.

19. The method of claim 5, wherein in the atmospheric plasma spraying of operation (3), a powder feeding rate is in a range of 2-10 g/min, and
a powder feeding manner includes vertical jet powder feeding.

20. The method of claim 5, comprising:
(1) mixing the Al powder, the Co powder, the Ni powder, the Cu powder, and the Ti powder according to the molar ratio, then performing the gas atomization and sieving, to obtain the high-entropy alloy powder with a particle size in a range of 25-75 μm, wherein the gas atomization includes:
under inert gas protection, performing repeated melting on the Co powder, the Ni powder, the Cu powder, and the Ti powder with purities all larger than or equal to 99.9% for 3-5 times until molten droplets fall, then performing high-pressure atomization using argon, wherein a vacuum degree during the gas atomization is in a range of 2.5×10⁻⁴-3.5×10⁻⁴ Pa, a melting power is in a range of 30-40 kW, and a pressure of the high-pressure atomization is in a range of 7.5-8.5 MPa;
(2) preheating the high-entropy alloy powder obtained in operation (1) to obtain the standby alloy powder, wherein a preheating temperature is in a range of 180-230° C., and a preheating time is in a range of 150-200 min; and
(3) performing the atmospheric plasma spraying on the surface of the brake disc base after pre-treatment using the standby alloy powder as the spraying material, to obtain the brake disc coating with a thickness in a range of 200-300 μm, wherein the pre-treatment includes sequentially performing sandblasting pre-treatment, cleaning, and drying on the surface of the brake disc base, a sandblasting material used in the sandblasting pre-treatment includes brown fused alumina sand, a compressed air pressure in the sandblasting pre-treatment is in a range of 0.3-0.8 MPa, an angle between a spray gun and the surface of the brake disc base in the sandblasting pre-treatment is in a range of 40-50°, and the cleaning includes using a degreaser for cleaning treatment, and
in the atmospheric plasma spraying, a spraying distance is in a range of 100-150 mm, a hydrogen flow rate is in a range of 3-6 L/min, an argon flow rate is in a range of 30-50 L/min, a spraying current is in a range of 480-550 A, a spraying voltage is in a range of 50-60 V, a torch moving velocity is in a range of 150-400 mm/s, a spraying spacing is 3 mm, a powder feeding rate is in a range of 2-10 g/min, a powder feeding manner includes vertical jet powder feeding, and repeated passes are in a range of 4-6 times.
